(19) United States
(12) Patent Application Publication
(10) Pub. No.: US 2023/0157304 A1
(43) Pub. Date: May 25, 2023

(54) Methods and Apparatus for Powder and/or Topping Deposition

(71) Applicant: Frito-Lay Trading Company GmbH, Berne (CH)

(72) Inventors: Simon Kew, Duxford Cambridge (GB); Jonathan Waite, Duxford Cambridge (GB); Simon Lawton, Leicester Leicestershire (GB); Lindsay Dobson, Leicester Leicestershire (GB); Paul Hetherton, Leicester Leicestershire (GB)

(21) Appl. No.: 17/919,870

(22) PCT Filed: Apr. 21, 2021
(86) PCT No.: PCT/EP2021/060314

§ 371 Date: Oct. 19, 2022

(30) Foreign Application Priority Data
Apr. 21, 2020 (GB) 2005814.5

(51) Int. Cl. A21C 15/00; A23G 3/34; A23P 20/12; B05C 19/04; B05C 5/00; B05D 1/30; A21C 9/04; B05C 9/06

(52) U.S. Cl. CPC A21C 15/002; A23G 3/0085; A23P 20/12; B05C 19/04; B05C 5/002; B05D 1/30; A21C 9/04; B05C 9/06

(57) ABSTRACT

A production line for powder coating items, such as food pieces, having a conveyor and a powder depositor arranged having a powder reservoir, a screen, a vibratory actuator to apply intermittent vibrations to the screen to cause powder to pass through apertures in the screen; and a controller to control the interval between the intermittent vibrations so that powder is deposited predominantly onto the items as they pass below the screen.

### FIELD OF THE INVENTION

The invention relates to methods and apparatus for the deposition of powders and/or toppings onto moving objects, and particularly onto moving food items, e.g. on a conveyor belt. Particular features relate to the deposition of powdered flavourings, seasonings, colourings and/or other toppings onto moving food items.

Background and Prior Art

In the food industry, it is often required to apply a powdered ingredient, such as a flavouring or colouring to the top surface of a food item during processing. FIG. 1 illustrates, in perspective view, a typical arrangement. Food items 1 are conveyed, in lanes, by a conveyor 2, typically a conveyor belt. A hopper 3 is provided to hold the powdered ingredient 4 and distribute it (e.g. by means of a vibratory feeder 5) as a curtain 6, onto the surface of a row of food items 1 as they pass below. Terminology used herein in relation to “lanes” and “rows” will be described in relation to FIG. 3, below.

This method of applying powdered ingredients has the disadvantage that quite a lot of the powdered material can end up on the conveyor itself, rather than on the food items. Not only can this lead to wastage, but could potentially require regular cleaning of the conveyor to prevent buildup of powder, and possible microbiological risks. In some applications, items to be coated are carried on cords so that unused seasoning passes through to a lower collection system for recycle—a typical recycle can be up to 300% of that which adheres to the food items. This recycle is often hygroscopic due to sugars and other ingredients in the seasoning which then leads to agglomeration, and undesirable spotting and poor adhesion. Additionally the recycle system must be cleaned causing lost production time. The use of a curtain of seasoning can also result in flyaway particles of dust that adhere to surfaces in the vicinity; this also requires additional cleaning and lost production. These issues are especially problematic when the food items are fast-moving.

It is among the object of the present invention to propose a solution to the problem.

### SUMMARY OF THE INVENTION

Accordingly, the invention provides a production line for producing items having powder and/or a topping deposited on them, said production line comprising a conveyor arranged to convey items to be coated and a powder and/or topping depositor arranged to deposit powder and/or toppings in items on said conveyor; said powder and/or topping depositor comprising: (a) a powder and/or topping reservoir to hold powder and/or topping to be deposited; (b) a screen, positioned to receive powder and/or topping from said reservoir onto a face of said screen; (c) a vibratory actuator arranged to apply intermittent vibrations to said screen to cause powder and/or topping to pass through apertures in said screen; (d) a controller to control the interval between said intermittent vibrations such that powder and/or topping is deposited predominantly onto said items as they pass below said screen.

Preferably, said items are arranged in plural lanes on said conveyor, said line comprising a plurality of powder and/or topping depositors arranged to deposit powder and/or topping on items in a plurality of corresponding lanes.

Preferably also, a plurality of powder and/or topping depositors are arranged to deposit powder and/or toppings on items in a plurality of rows of items on said conveyor.

Also included in the scope of the invention is production line as described above comprising a powder and/or topping depositor in which said vibratory actuator is configured to also apply intermittent vibrations to said reservoir.

Preferably, said intermittent vibrations have a dominant frequency of between 1 and 200 kHz, preferably between 5 and 100 kHz, more preferably between 10 and 50 kHz, and most preferably between 10 and 30 kHz.

Preferably such a production line comprises a powder and/or topping depositor in which said screen is supported on a baseplate, and said vibratory actuator is functionally connected to said baseplate to enable vibration of said screen.

More preferably, such a production line comprises a powder and/or topping depositor in which said reservoir is also functionally connected to said baseplate such that said vibratory actuator can also enable vibration of said reservoir.

In any such production line it is preferred that said line comprises a powder and/or topping depositor in which said vibratory actuator comprises a piezo-electric actuator.

In any such production line it is preferred that said line comprises a powder and/or topping depositor in which said controller is configured to deliver said intermittent vibrations at a repeat rate of between 2 and 30 Hz, preferably between 6 and 15 Hz.

In any such production line it is preferred that said line comprises a powder and/or topping depositor in which said screen comprises a mesh. More preferably, said mesh comprises apertures of between 0.2 and 7 mm, for example between 1.0 and 6 mm.

Alternatively, it is preferred that said screen comprises a perforated plate.

In any such production line, it is preferred that said conveyor is configured to convey said items at a velocity of 0.1 to 3 m/s, preferably between 0.2 and 1.5 m/s, more preferably between 0.25 and 1.3 m/s, most preferably between 0.6 and 1.1 m/s. Such velocity can result in a production line that can deposit powder and/or toppings onto items at a rate of 10-12 items per second per lane. A typical production might run with 20-24 lanes giving production rates of 240-288 items per second.

In any such production line it is preferred that said line comprises a powder and/or topping depositor configured to deposit powder and/or topping only on a part of an item.

In any such production line it is preferred that said line further a sensor, arranged to sense the presence or absence of an item to be coated, and configured to send a signal to a controller to control deposition of powder and/or topping onto said item.

In any such production line it is preferred that said line comprises plural powder and/or topping depositors arranged along a lane and configured to deposit powder and/or topping onto different items.

In any such production line it is preferred that said line comprises plural powder and/or topping depositors and wherein the vibratory actuators in multiple powder and/or topping depositors are provided with a driving signal from a common signal generator. More preferably, said driving signal is independently controlled in each of said multiple powder and/or topping depositors to allow independent intermittent vibrations for each of said multiple powder and/or topping depositors.

In any such production line it is preferred that the line further comprises charging apparatus configured to impart an electrostatic charge to said powder.

Also falling within the scope of the invention is the use of a production line described above wherein said items are food pieces, for example, crackers or chips.

Also falling within the scope of the invention is a powder and/or topping depositor array for use in such a production line.

### BRIEF DESCRIPTION OF THE FIGURES

The invention will be described with reference to the accompanying drawings, in which:

FIG. 1 is a schematic perspective view of a prior art powder deposition system;

FIG. 2 is a schematic cross-section of a powder and/or topping depositor;

FIG. 3 is a plan view of items on a conveyor;

FIGS. 4A-4D are plan views of screens and vibratory actuators being part of a powder and/or topping depositor;

FIG. 5 is a schematic elevation view of a production line for powder and/or topping deposition;

FIGS. 6-9 illustrate various arrangements of powder and/or topping depositors on a production line;

FIG. 10 is a schematic illustration of a production line of the invention; and

FIGS. 11-13 are graphs illustrating the performance of powder and/or topping depositors.

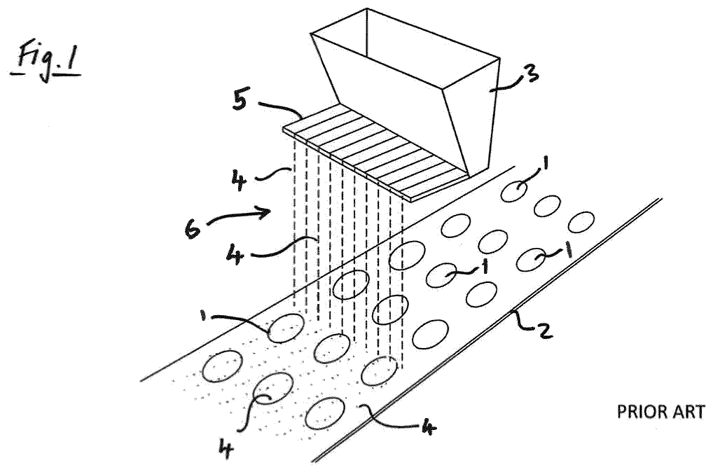

### DESCRIPTION OF PREFERRED EMBODIMENTS

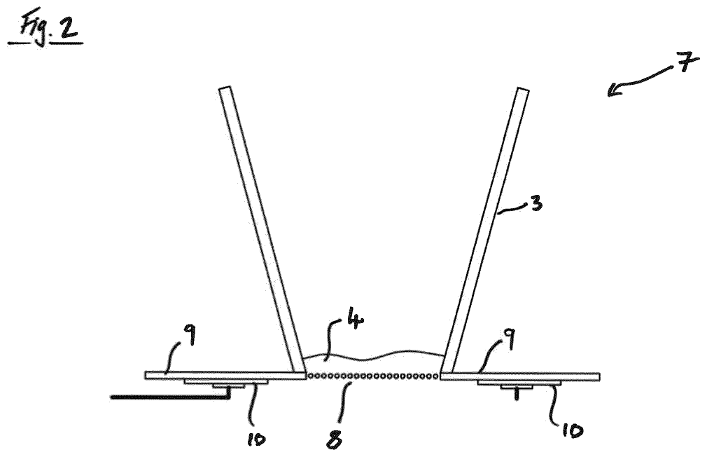

FIG. 2 illustrates, in cross-sectional view, a powder and/or topping depositor according to an embodiment of the invention, generally indicated by 7. The depositor 7 comprises a powder and/or topping reservoir 3, such as a conical reservoir, into which is introduced powder and/or topping 4 to be deposited.

The term “powder” as used herein means particles having a typical particle size distribution of 10-400 microns. The term “powder” is intended to include salt, seasonings and colourings. Examples of seasonings include bbq flavouring, dairy powder (e.g. sour cream), herbs, spices, and sugar. Seasonings may also be pre-blended mixtures.

The term “topping” as used herein means particulates which are physically discernible pieces. The topping may have a typical particle size distribution of greater than 1 mm, for example 1-10 mm or 1-7 mm. However, in some embodiments, the topping particulates may have a particle size distribution of less than 1 mm but are not a homogenous powder. Toppings that may be deposited using the powder and/or topping depositor according to the invention include nuts (e.g. pine nuts, chopped cashews etc), vegetable pieces (e.g. chilli flakes, crushed chilli, carrot pieces, olive pieces, herb pieces, peppercorns, etc), seeds (e.g. poppy seeds, chia seeds etc), edible spices (e.g. cumin seeds), confectionary pieces (e.g. “Nerds”, popping candy, etc.), large sugar crystals, rock salts, and/or processed food fragments (e.g. crushed potato chips, tortilla chips etc). Where larger toppings are used, the toppings may be pre-sieved to narrow the particle size distribution.

The introduction of powder and/or topping into the reservoir 3 may be achieved by e.g. the use of a vibratory feeder, a screw feeder, a conveyor belt, or other such means as will be apparent to the skilled addressee. The depositor also comprises a screen 8 that is arranged to receive powder and/or topping 4 from the reservoir 3. In this embodiment, the screen 8 is mounted across an aperture in a baseplate 9. The screen could comprise a wire mesh, e.g. a woven mesh, or other perforated structure as will be described below.

A vibratory actuator is also provided, in this embodiment in the form of piezo-electric actuators 10, driven by a suitably amplified signal source. Suitable arrangements will be described below.

In this embodiment, the reservoir 3 is coupled to the baseplate 9, such that vibrations applied to the baseplate 9 are transmitted to the walls of the reservoir 3 to assist with flow of powder and/or topping 4 towards the screen 8. In alternative embodiments, separate vibratory actuators could also be attached directly to the reservoir 3 itself.

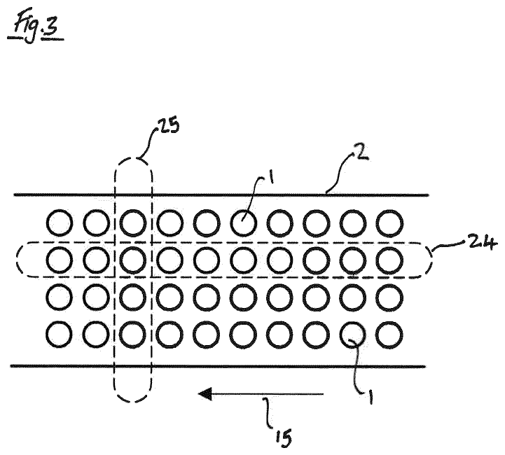

FIG. 3 illustrates, for the purpose of clarification of terminology, items to be coated 1 travelling on a conveyor 2, in the direction shown by arrow 15. The array of items enclosed by the dashed region 24 is part of what is referred to as a “lane”, i.e. an array of items arranged parallel to the direction of movement of the conveyor 2. There are four such lanes illustrated in this example. The array of items enclosed by the dashed region 25 is referred to as a “row”; i.e. an array of items arranged substantially perpendicularly to the direction of travel of the conveyor. There are ten such rows illustrated in this example.

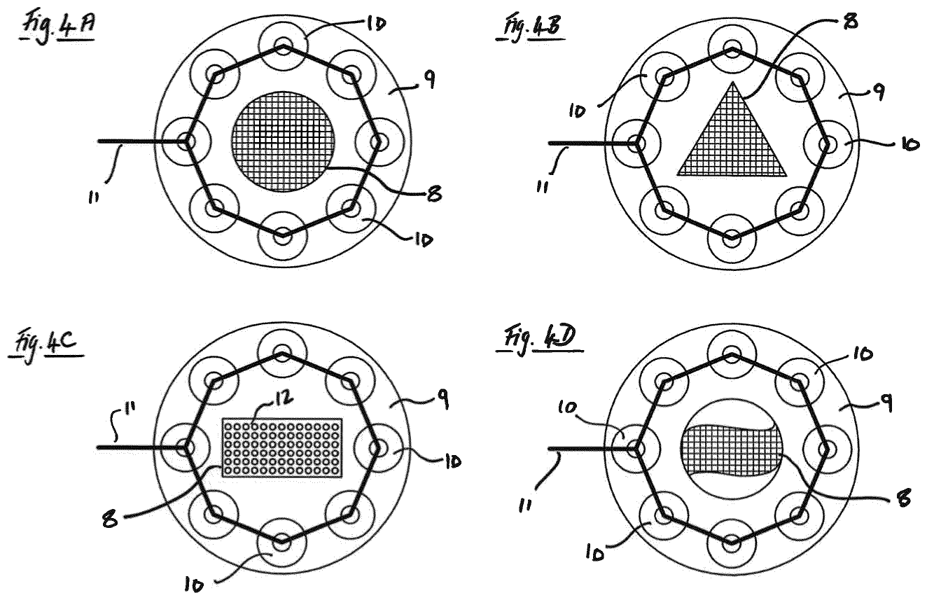

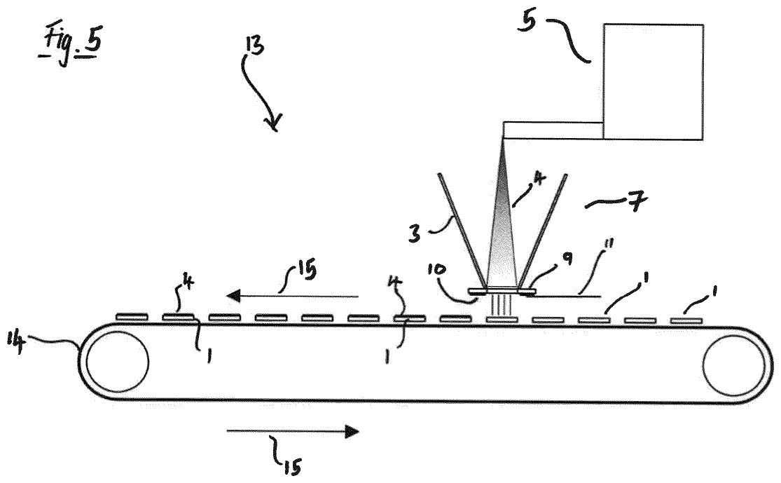

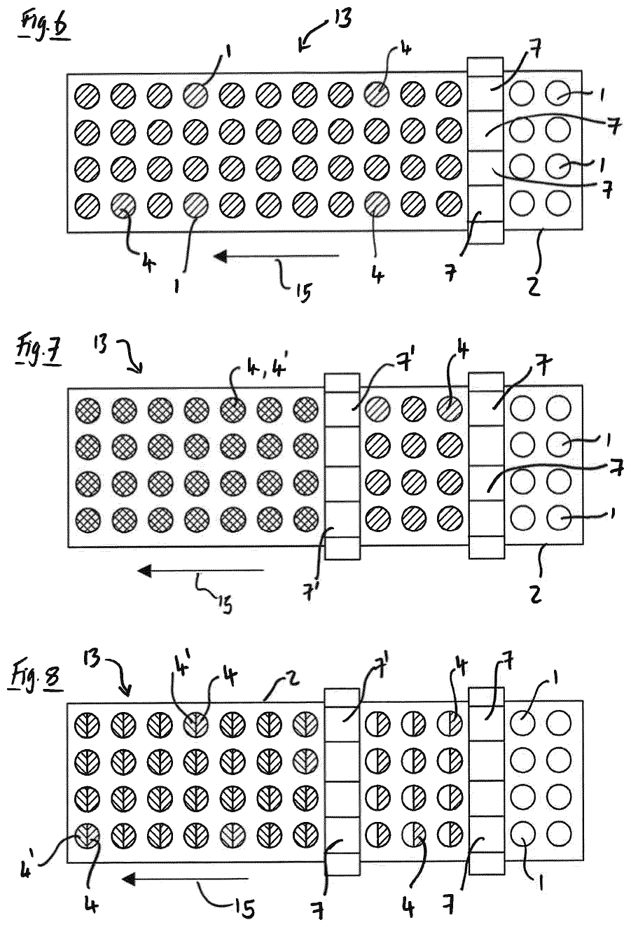

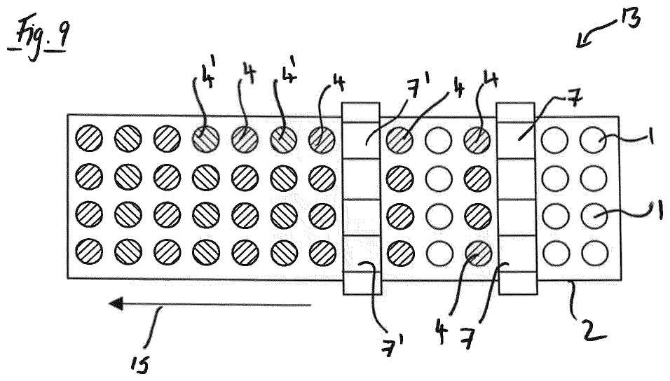

FIGS. 4A-4D illustrate various arrangements of screens 8 in different embodiments of the invention. In each case, the screens are arranged over an aperture in a baseplate 9. Also illustrated are vibratory actuators in the form of piezo-electric actuators 10, bonded to the baseplate 9. Wiring 11 connects the actuators to a signal source (not illustrated).

In FIG. 4A, a circular screen 8 in the form of a woven mesh is provided of approximately the same size and shape of a food item e.g. a savoury snack on which powder and/or topping is to be deposited.

In FIG. 4B, a triangular screen 8 is provided, of approximately the same size and shape of a food item e.g. a triangular savoury snack on again which powder and/or topping is to be deposited.

In FIG. 4C a screen 8 is provided as an array of perforations in a screen plate mounted on the baseplate 9. Such perforations could also be provided directly through the baseplate 9. In this example, the perforations are shown to be circular, but they could also be of other shapes, such as square, triangular, hexagonal or elliptical.

In FIG. 4D a screen 8 is provided having a shape smaller than the shape of a food item e.g. a savoury snack on which powder and/or topping is to be deposited. In this instance, the food item is circular, and the screen shape represents a “sash” across the circle. In this way, when a coloured powder and/or topping is used, an icon can be effectively printed onto the food item.

In some embodiments, the screen may have a gradient. For example, the gradient may be radial, linear or non-liner. A gradient screen can be used with a single particle type or multiple particle types.

In some embodiments, the screen may be bi-modal, for example, the screen may comprise a first part and a second part. The first and second parts may be of equal size or of unequal sizes. The first and second parts may have the same or different aperture sizes. The first and second parts may be of the same configuration (aperture shape, gradient, pattern etc) or may be of different configuration (aperture shape, gradient, pattern etc). The first part and the second part may be fed from the same reservoir or may be fed from different reservoirs.

In some embodiments, the screen may be multi-modal. For example, the screen may comprise three or more parts of equal or unequal sizes. Each of the parts may have the same or different aperture sizes. Each of the parts may be of the same configuration (aperture shape, gradient, pattern etc) or may be of different configuration (aperture shape, gradient, pattern etc). Each of the parts may be fed from the same reservoir or may be fed from different reservoirs.

In some embodiments, the screen may be planar. In other embodiments, the screen may be three-dimensional, for example, upright or inverted cone, hemispherical, pyramidal etc. Where there is more than one screen, there may be a mixture of planar and three-dimensional screens used. Three-dimensional screens may have advantages such as enabling the flow of otherwise layering materials (such as flakes) by enabling the aperture to be perpendicular in plane to the settled layer (much like posting a letter through a letter box). This can be beneficial as flake-like toppings can tend to settle in flat layers that can block two-dimensional planar apertures.

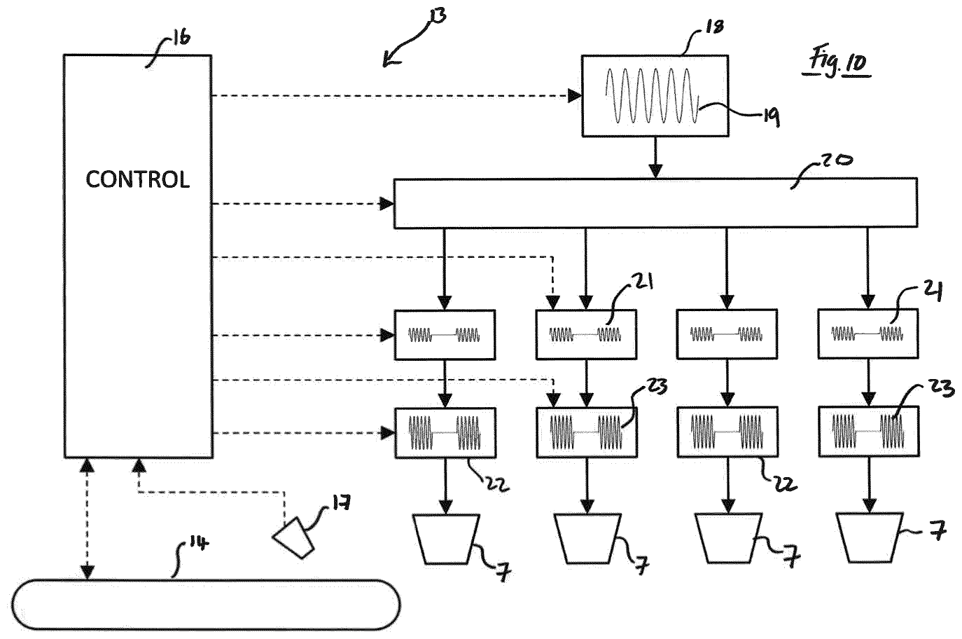

FIG. 5 illustrates, in schematic elevation view, a production line for producing item having a powder and/or topping coating, generally indicated by 13. The line 13 comprises a conveyor belt 14 moving as illustrated by the arrows 15. Food items 1 are conveyed under a powder and/or topping depositor 7 fed with powder and/or topping via a vibratory feeder 5. A control system (not illustrated) sends an intermittent oscillatory signal via wiring 11 to vibratory actuators 10 mounted on the baseplate to cause powder and/or topping 4 to be deposited on the surface of the food items 1. The control system is configured to send the intermittent oscillatory signal to the actuators in synchrony with the food items passing beneath the depositor (7), allowing for the time for the powder and/or topping to fall from the screen, to the food items such that an aliquot of powder and/or topping is deposited substantially only on the food items 1. In some embodiments, the distance from the screen to the food items is referred to as the dispense height. The dispense height is preferably high enough to avoid products colliding with the screen. A low dispense height results in a sharp pattern whereas a higher dispense height can cause more “bounce” on impact resulting in diffusion of the particles at the surface, this can be desirable for powder deposition where the objective is uniform coverage. In some embodiments, the dispense height is about 20 cm, preferably about 10 cm, more preferably about 5 cm, even more preferably about 1 cm. A sensor (not illustrated), such as an electric eye, may be used to detect the presence/absence of food items on the conveyor, and send signals to the controller to achieve such synchrony.

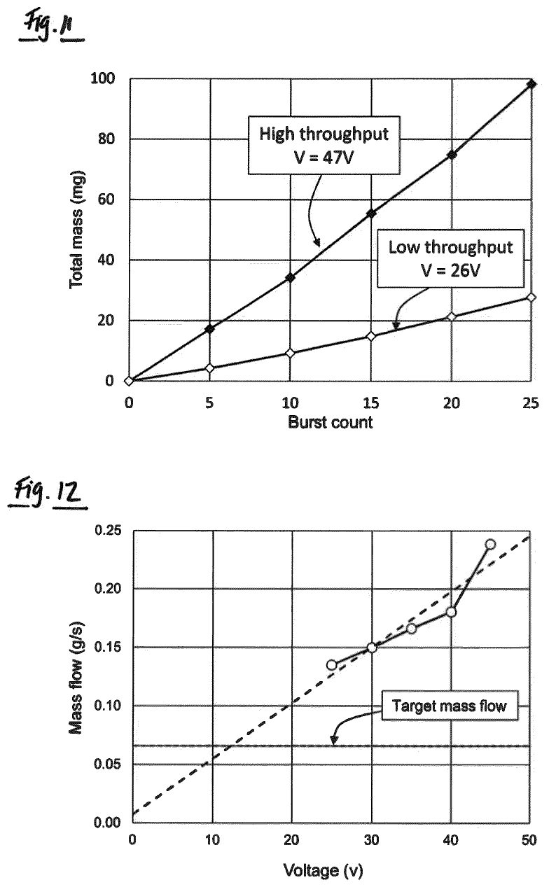

m FIGS. 6-8 illustrate in schematic plan view, embodiments of production lines 13 for producing food items with a powder and/or topping deposit.

In each embodiment, food items 1 are fed onto a conveyor 2 which transports them in a direction indicated by the arrows 15. Also in each embodiment, four lanes of food items are illustrated. In practice, for the production of snack foods, it is likely that many more lanes, e.g. six, eight or even ten might be typical.

In FIG. 6, four powder and/or topping depositors 7 are provided, each one positioned above a lane of food items. In the illustration, the depositors 7 are shown at the same position relative to the length of the conveyor, i.e. positioned across the same row. This may be advantageous as they can be provided as e.g. a single cassette of depositors having multiple screens. In other arrangements, the depositors could be arranged in a staggered fashion along the direction of movement of the conveyor 2.

In the example illustrated in FIG. 6, the controller (not illustrated) is configured to deposit powder and/or topping 4 on each food item 1 as it passes below its respective powder and/or topping depositor 7. This is illustrated by the angled hatching of the representations of the food items 1.

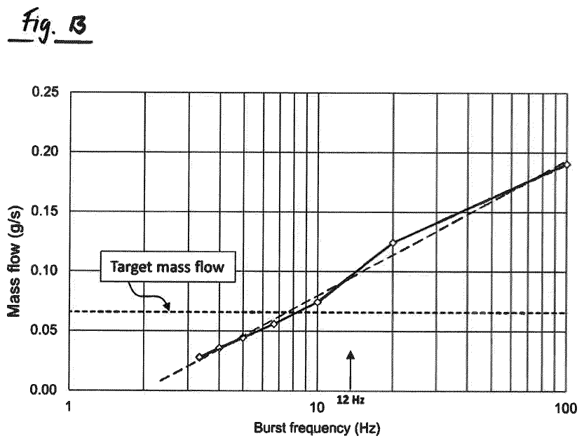

In FIG. 7, two depositors 7, 7′ are provided for each lane, and configured to deposit two different powders and/or toppings 4, 4′ sequentially on the food items, illustrated by the single and double hatching of the representations of the food items 1.

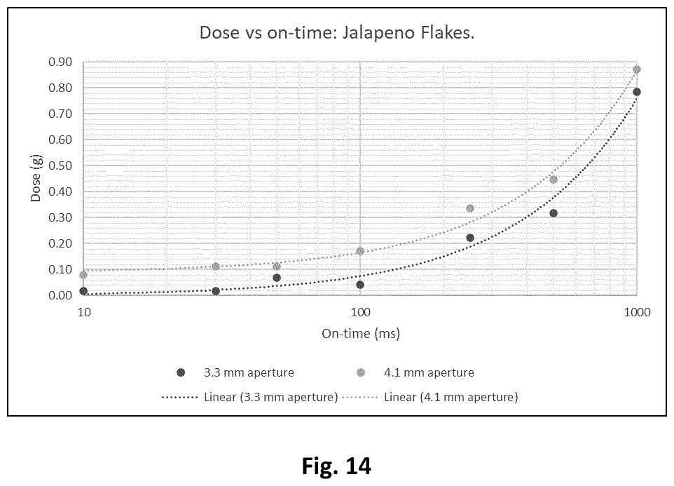

In FIG. 8, two depositors 7, 7′ are provided for each lane, and configured to deposit two different powders and/or toppings 4, 4′ sequentially on the food items, illustrated by the single and double hatching of the representations of the food items 1. In this embodiment, however, the first set of depositors 7 only deposit powder and/or topping 4 onto part of the food items 1, in this illustration depositing powder and/or topping onto half of the product. The second set of depositors 7′ only deposit powder and/or topping 4′ onto the previously uncoated half of the food items. In this way, products may be produced that have different flavour characteristics on opposite ends of the product.

In some embodiments, the powder/topping reservoir may be divided into two or more zones (divided hopper). This enables the depositor to deposit multiple toppings in the same deposition.

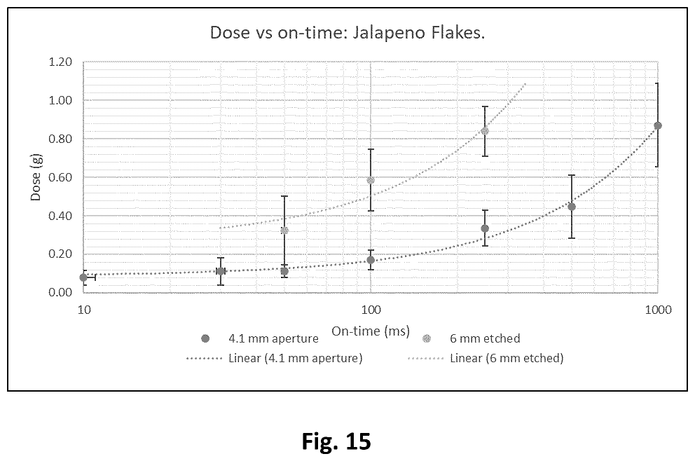

FIG. 9 illustrates, again in schematic plan view, an embodiment of a production line, generally indicated by 13. Like elements described in FIGS. 6-8 are correspondingly numbered in FIG. 9. In this embodiment, the first set of four depositors 7 deposit (under the control of the controller—not illustrated) powder and/or topping 4 on alternate rows of food items 1, with the second set of depositors 7′ depositing powder and/or topping 4′ on the remaining alternate rows of food items 1. In this way, two differently flavoured food items can be produced on the same production line. For products in which multiple food items are packaged together (e.g. potato chips or savoury snacks) this allows a single pack to contain multiple flavours, without having to mix food items from two different production lines. Where the food items are stacked together, every other item could e.g. have a different flavour. It will be apparent to the skilled addressee that more than two different flavours or colours could be applied in this way, and that combinations of the configurations described for FIGS. 6-9 may be made primarily by changing the behaviour of the controller.

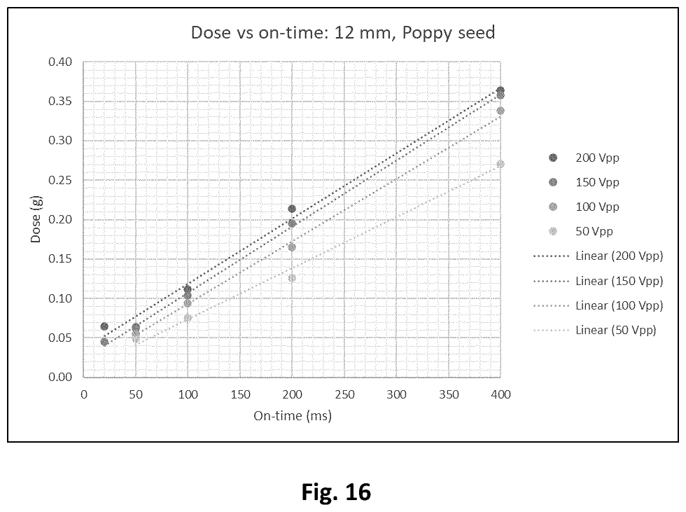

FIG. 10 illustrates, schematically, an embodiment of a production line of the invention, generally indicated by 13. A conveyor belt 14 conveys food items (not illustrated) below powder and/or topping depositors 7 as described herein. Information on the speed of the conveyor belt may be transmitted to the controller 16, or alternatively the controller 16 might control the speed of the conveyor itself. Sensors 17 may also be provided to detect the presence or absence of food items on the conveyor belt 14, with this information also being transmitted to the controller 16. A signal generator 18 is provided to generate an oscillating signal 19 that will be used to drive the oscillation of the screens 8 in the powder and/or topping depositors 7. The applicant has found that signals having a predominant frequency of between 1 and 200 kHz, preferably between 10 and 50 kHz, and most preferably between 10 and 20 kHz is ideal for causing the deposition of powdered flavourings and/or toppings often used in snack foods. Such a signal allows for fast deposition of powdered flavourings which when used with powder and/or topping depositors arranged along lanes, vastly increases production outputs. Such a signal might e.g. be sinusoidal or square wave, or another profile. The signal 19 is fed through a gating mechanism 20 under the control of the controller 16 to produce a driving signal in the form of a pulse train 21. Each individual pulse can retain the original dominant frequency from the signal generator, with the pulse width and pulse separation selected such that the pulse repetition rate coincides with that required to produce the desired powder and/or topping deposition as discussed above in relation to FIGS. 6-9. In a typical production line for snack items, a pulse repetition rate in the rage of 5 to about 50 Hz might be required, e.g. about 12±1 Hz.

The pulse train 21 is then fed though amplifiers 22 to producing an amplified driving pulse train 23 that may be used to drive the vibratory actuators of the powder and/or topping depositors 7. The amplification provided by the amplifiers 22 (i.e. the amplifier gain) may be controlled by the controller 16. It will be appreciated by the skilled addressee that the order of application of the amplification and gating steps may be interchanged.

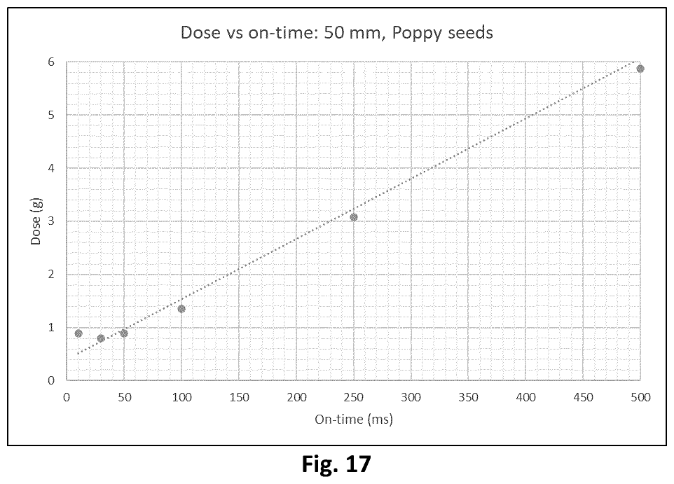

FIG. 11 presents results from a test of an embodiment of a powder and/or topping depositor of the invention. The powder used in this test was salt, using a mesh screen of 10 mm diameter using a signal frequency of 100 kHz. The mass of powder deposited was measured after 5, 10 15, 20 and 25 bursts (i.e. pulses). The essentially linear relationship between mass and burst count indicates the consistency of dosing. Additionally, the amplitude of the driving pulse train applied to the vibratory actuators (in this case, piezo-electric actuators) was varied. It can be seen that changing the pulse amplitude from 26V to 47V results in an increase in the powder and/or topping deposition rate. This relationship can therefore be used to control the dosing of the powders and/or toppings onto the food items.

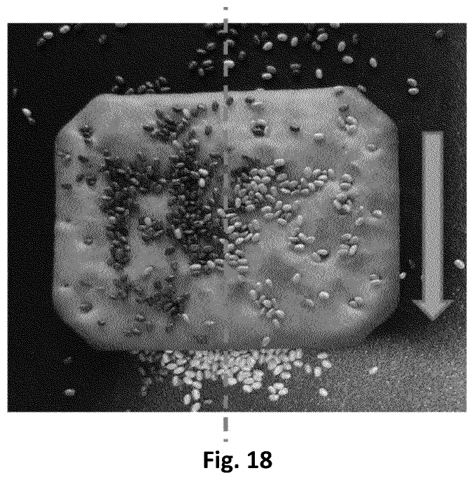

FIG. 12 shows the result of continuous dosing (i.e. with the gating omitted) the voltage applied to the vibratory actuators can be related approximately linearly to the dosing rate.

FIG. 13 shows the result of increasing the burst frequency (i.e. pulse repetition rate) on the mass flow of powder and/or topping. There is a logarithmic relationship between the burst frequency and the mass flow of powder and/or topping, reflective of the fact that burst frequency is proportional to duty cycle “on time” and so e.g. 100 Hz is on for 10× the time of 10 Hz.

FIG. 14 presents results from a test of an embodiment of a powder and/or topping depositor of the invention. The topping used in this test was chilli flakes (jalapeno flakes). The test compares mesh screens with apertures of 3.3 and 4.1 mm. The voltage peak to peak (Vpp) was 200V and the length of the deposition pulse was varied between 10 m/s and 1000 m/s. The signal had a predominant frequency of 10 kHz and was square wave. The signal was modulated by short bursts of 100 Hz square wave. As a result in the variation in the length of the deposition pulse, the dosing was varied. It was found that there was good deposition of chilli flakes at short dispenses for both mesh screens with both 3.3 mm apertures and 4.1 mm apertures.

FIG. 15 presents results from a test of an embodiment of a powder and/or topping depositor of the invention. The topping used in this test was chilli flakes (jalapeno flakes). The test compares mesh screens with apertures of 4.1 mm (woven wire) and 6 mm (chemically etched mesh from a plate). The voltage applied was 150V and the length of the deposition pulse was varied between 10 m/s and 1000 m/s (for the 4.1 mm aperture) and between 50 m/s and 250 m/s (for the 6 mm screen). The signal had a predominant frequency of 10 kHz and was square wave. The signal was modulated by short bursts of 100 Hz square wave. The conveyor belt was moving at 12 m/min and the dispense height was 1 cm. As a result in the variation in the length of the deposition pulse, the dosing was varied. It was found that the 6 mm mesh was preferable for chilli flakes leading to almost double throughput compared with the 4.1 mm mesh. It was also found that there was higher variation at lower dose and therefore higher dose was preferred for consistency. An optimum dose for chilli flakes was found to be 0.4 g, achieved with the 6 mm square etched meh screen with 150V and 70 m/s deposition pulse.

FIGS. 16 and 17 present results from a test of an embodiment of a powder and/or topping depositor of the invention. The topping used in this test was poppy seeds. FIG. 16 shows the dose compared with the actuation duration (on-time) for a 12 mm linear “slot” dispenser. FIG. 17 shows the dose compared with the actuation duration (on-time) for a 50 mm circular (round) dispenser. The voltage peak to peak (Vpp) is the driving force applied to the piezo electric. Target dispense mass per unit area could be achieved for both 12 mm and 50 mm dispenser. However, it was found that the 12 mm slot type dispenser gave a more linear response.

FIG. 18 shows a mixed-topping sample. The toppings in this example were black and white chia seeds. The seeds were deposited via a 1.6 mm mesh using a divided hopper. The voltage applied was 200 V at 90 ms leading to a dose of 0.8 g. The dispense height was 1 cm and the food pieces were conveyed at a velocity of 0.2 m/s (12 m/min). The food pieces were commercially available crackers which were used without application of adhesives or glazing.

A variety of powders and/or toppings have been tested for flowability using an embodiment of a powder and/or topping depositor of the invention. The results of these results are shown in the table below.

| | Carr's | | | Angle of | |
|---|---|---|---|---|---|
| Target | number | Hausner | Flowabil- | repose | Angle +/− |
| Topping | (%) | Ratio | ity | (deg) | (deg) |
| Poppy seeds | 8.76 | 1.09 | Excellent | 49.4 | 2.7 |
| Chilli flakes | 12.96 | 1.15 | Good | 46.4 | 0.9 |
| Chilli crushed | 11.73 | 1.13 | Good | 41.8 | 4.0 |
| Chopped cashews | 11.07 | 1.12 | Good | 47.0 | 4.9 |
| Pine nuts | 7.93 | 1.09 | Excellent | 38.8 | 2.7 |
| Carrot flakes | 8.7 | 1.1 | Excellent | 46.8 | 2.2 |
| Olive pieces | 12.4 | 1.14 | Good | 43.5 | 1.7 |

This table summarizes the flow characteristics of various toppings used. The Hausner ratio and Can index are both derived from measurements of changes in bulk density from an initial “as poured” or fluffy density to that in a “conditioned” state where the sample is consolidated in a controlled manner. These two ratios are then used to categorise the flowability of the materials using empirical guidelines. Similarly the angle of repose is a measure of internal friction and propensity the “jam” with lower angle of repose being less likely to jam than high angles. What can be seen in the table is that all of the toppings tested had either “good” or “excellent” flow characteristics. What can also be seen from the table is that all of the toppings had similar angles of repose and yet the toppings all behaved differently in real world testing with the depositor.

1. A production line for producing items having a powder coating and/or a topping, said production line comprising a conveyor arranged to convey items to be coated and a powder and/or topping depositor arranged to deposit powder and/or toppings on items on said conveyor; said powder and/or topping depositor comprising:
(a) a powder and/or topping reservoir to hold powder and/or topping to be deposited;
(b) a screen, positioned to receive powder and/or topping from said reservoir onto a face of said screen;
(c) a vibratory actuator arranged to apply intermittent vibrations to said screen to cause powder and/or topping to pass through apertures in said screen;
(d) a controller to control the interval between said intermittent vibrations such that powder and/or topping is deposited predominantly onto said items as they pass below said screen.

2. A production line according to claim 1 in which said items are arranged in plural lanes on said conveyor, said line comprising a plurality of powder and/or topping depositors arranged to deposit powder and/or topping on items in a plurality of corresponding lanes.

3. A production line according to claim 1 wherein a plurality of powder and/or topping depositors is arranged to deposit powder and/or topping on items in a plurality of rows of items on said conveyor.

4. A production line according to claim 1 wherein the vibratory actuator is configured to apply intermittent vibrations to said reservoir.

5. A production line according to claim 1 wherein the intermittent vibrations have a dominant frequency of between 1 and 200 kHz.

6. A production line according to claim 1 wherein the screen is supported on a baseplate, and said vibratory actuator is functionally connected to said baseplate to enable vibration of said screen.

7. A production line according to claim 6 wherein the reservoir is also functionally connected to said baseplate such that said vibratory actuator can also enable vibration of said reservoir.

8. A production line according to claim 1 wherein the vibratory actuator comprises a piezo-electric actuator.

9. A production line according to claim 1 wherein the controller is configured to deliver said intermittent vibrations at a repeat rate of between 2 and 30 Hz.

10. A production line according to claim 1 wherein the screen comprises a mesh.

11. A production line according to claim 10 wherein the mesh comprises apertures between about 0.2 mm and about 7 mm.

12. A production line according to claim 1 wherein the screen comprises a perforated plate.

13. A production line according to claim 1 in which said conveyor is configured to convey said items at a velocity of 0.1 to 3 m/s.

14. A production line according to claim 1 wherein the powder and/or topping is deposited only on a part of an item.

15. A production line according to claim 1 further comprising a sensor arranged to sense the presence or absence of an item to be coated and configured to send a signal to a controller to control deposition of powder and/or topping onto said item.

16. A production line according to claim 1 in which plural powder and/or topping depositors are arranged along a lane and are configured to deposit powder and/or topping onto different items.

17. A production line according to claim 1 comprising plural powder and/or topping depositors and wherein the vibratory actuators in multiple powder and/or topping depositors are provided with a driving signal from a common signal generator.

18. A production line according to claim 17 wherein said driving signal is independently controlled in each of said multiple powder and/or topping depositors to allow independent intermittent vibrations for each of said multiple powder and/or topping depositors.

19. A production line according to claim 1 further comprising a charging apparatus configured to impart an electrostatic charge to said powder and/or topping.

20. (canceled)

21. (canceled)
